(19) United States
(12) Patent Application Publication
(10) Pub. No.: US 2009/0074255 A1
(43) Pub. Date: Mar. 19, 2009

(54) APPARATUS AND METHOD FOR CAPTURING SKIN TEXTURE BIOMETRIC IN ELECTRONIC DEVICES

(75) Inventor: Paige Holm, Phoenix, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 11/857,087

(22) Filed: Sep. 18, 2007

(51) Int. Cl. G06K 9/00

(52) U.S. Cl. 382/115; 382/124

(57) ABSTRACT

A method is provided for enabling a function on an electronic device (110, 210, 410) comprising a touch input device (112, 116, 212, 218, 312, 424, 432) including a plurality of pixels having a surface (316) for providing radiated energy having one or more spectral bands, and a plurality of photosensors (340), at least one each of the photosensors (340) being incorporated within each of the pixels. The method comprises, during functional (normal) use of the electronic device by a user, sensing (512) a portion of a touch input device (112, 116, 212, 218, 312, 424, 432) touched by the user's skin, applying (514) radiant energy to the skin from only that portion of the touch input device (112, 116, 212, 218, 312, 424, 432) touched, and collecting (516), by the plurality of photosensors (340), radiant energy reflected from the skin. The collected radiant energy is converted (624) into data and a function of the electronic device (112, 116, 212, 218, 312, 424, 432) is enabled (530) when the data corresponds to a reference sample.

### FIELD OF THE INVENTION

The present invention generally relates to verifying the identity of a person, and more particularly to a method for identifying and verifying an approved user of an electronic device.

### BACKGROUND OF THE INVENTION

Transactions of many types require a system for identifying a person (Who is it?) or for verifying a person's claimed identity (Is she who she says she is?). The term recognition refers to identification and verification collectively. Traditionally, three methods have been used for recognizing a person: passwords, tokens, and biometrics.

Biometrics refers to information measured from a person's body or behavior. Examples of biometrics include fingerprints, hand shapes, palm prints, footprints, retinal scans, iris scans, face images, ear shapes, voiceprints, gait measurements, keystroke patterns, and signature dynamics. The advantages of pure biometric recognition are that there are no passwords to forget or to give out, and no cards (tokens) to lose or lend.

In biometric verification, a user presents a biometric which is compared to a stored biometric corresponding to the identity claimed by the user. If the presented and stored biometrics are sufficiently similar, then the user's identity is verified. Otherwise, the user's identity is not verified.

In biometric identification, the user presents a biometric which is compared with a database of stored biometrics typically corresponding to multiple persons. The closest match or matches are reported. Biometric identification is used for convenience, e.g., so that users would not have to take time consuming actions or carry tokens to identify themselves, and also for involuntary identification, e.g., when criminal investigators identify suspects by matching fingerprints.

There is an ever-growing need for convenient, user-friendly security features on electronic devices. These devices have permeated our society and have become a primary mode of communication in voice, text, image, and video formats today, with the promise of even greater functionality in the future for high speed web access, streaming video, and even financial transactions. Authentication of the device user in these applications is of paramount importance and a significant challenge.

Biometric technologies are viewed as providing at least a partial solution to accomplish these objectives of user identity and different types of biometrics have been incorporated into wireless products for this purpose. The most common of these include fingerprint, face, and voice recognition. Most of these biometric technology implementations require some type of specialized hardware, e.g., swipe sensor or camera, and/or specific actions to be taken by the user to “capture” the biometric data, e.g., swiping or placing a finger, pointing a camera, or speaking a phrase. The special hardware adds unwanted cost to the product in a cost sensitive industry, and the active capture can make the authentication process inconvenient to use.

Accordingly, it is desirable to provide a biometric technology that can be implemented with existing sensing components of the wireless device and in which the biometric data capture occurs passively, or unobtrusively, during the normal operation of the device, without intentional and time consuming action of the user. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a wireless communication device having a finger pressing a touch screen;

FIG. 2 is a wireless communication device resting over a human ear;

FIG. 3 is a partial cross-section of a touch input display for use in accordance with the exemplary embodiment taken along line 3-3 of FIG. 2;

FIG. 4 is a block diagram of a wireless communications device in accordance with an exemplary embodiment; and

FIG. 5 is a flow chart illustrating the method of verifying a user of the wireless communication device in accordance with the exemplary embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention comprises a method of capturing a distinctive, physical biometric, i.e., skin texture, using a sensor incorporated within a touch input display in electronic devices and in the normal operation of the device, e.g., during texting, navigating menus, playing games, or a phone conversation. The method involves a standard enrollment process, e.g., a one time setup task including capturing skin texture data from one or more body parts for later comparisons, and an authentication process. The authentication process involves: 1) detecting a touch anywhere on the main device touchscreen, 2) optionally recognizing the device use mode for determining which enrollment samples with which to compare, e.g., use finger data when dialing, or ear or cheek data when talking, 3) illuminating a specific region of pixels on the touchscreen in response to the touch, 4) capturing the skin texture data, 5) comparing the skin texture data with reference data, and 6) making a decision based on the comparison.

Enhancements of previously known skin texture biometrics have recently been demonstrated that allow for recognition of individuals (see for example, U.S. Patent Publication No. 2006/0062438 A1 assigned to Lumidigm, Inc. and incorporated herein by reference). Multiple illumination sources, e.g., red, green, blue, and white light, both polarized and unpolarized, may be used to capture finger print images which reveal both surface and subsurface characteristics of the skin. These skin features, referred to as “textures”, can be measured on any skin surface (not just fingertips) and over much smaller areas than conventional fingerprints. The texture properties are similar from finger to finger and across different regions of the body, but are distinctive among individuals. Therefore, the texture properties can be used for identification purposes and could allow for different locations on the skin to be used for enrollment versus verification purposes.

Image capture of skin texture may occur in any of several modes during normal operation of the mobile phone having a touch input display. The most common user interface would very likely be through finger presses on the touch screen display or a touch key. Almost every interaction with the device will involve this type of activity, e.g., dialing phone numbers, navigating through menus, surfing the web, playing games, etc. FIG. 1 is an isometric view of an electronic device 110 comprising a display 112, individual touch pads 118, and a speaker 120, all encased in a housing 122. Some electronic devices 110, e.g., a cell phone, may include other elements such as an antenna, a microphone, and a camera (none shown). Furthermore, while the preferred exemplary embodiment of an electronic device is described as a mobile communication device, for example, cellular telephones, messaging devices, and mobile data terminals, other embodiments are envisioned, for example, personal digital assistants (PDAs), computer monitors, gaming devices, video gaming devices, cameras, and DVD players.

While the finger 124 is shown in FIG. 1 touching the touch screen 112, it should be understood that the exemplary embodiments could be implemented by touching one of the touch keys 118. Furthermore, two or more simultaneous touches by different fingers, or different parts of the body, may be illuminated and stored instead of a single touch.

A skin texture image can, in principle, be captured at every touch of a finger onto the screen and can be done passively without awareness of the user. This passive (surreptitious, unobtrusive) use means without any intentional action required by the user and possible without a realization by the user that it is taking place. To minimize distraction during illumination of the display for image capture, the position of the fingers touching the display could be sensed first, and then only the portions of the display fully covered by the skin contact points could be energized to provide illumination. In this way, the entire display would not have to be lighted for capture. Illumination of the entire display might be extremely distracting to the users and others in the vicinity, thereby compromising the unobtrusiveness of the biometric capture, while providing for inefficient use of limited battery energy on the mobile device. It is noted that the remainder of the display not including the portion touched by the skin may display an image, e.g., the image existing prior to the skin being sensed.

For passive, or unobtrusive, capture of biometric data, fingerprints may not be the best option because in a typical interaction with a touch screen, only the tips of the fingers contact the screen during the input stroke. The tip of the finger has a low density of ridge information compared with that on the flatter, pad portion of the finger, where the fingerprint core exists, and therefore makes for very poor fingerprint matching results. On the other hand, rich skin texture data can be captured easily from the smaller areas of the fingertips and used effectively in the matching process.

Skin texture meets most of the criteria for a good biometric. They are universal (all humans), they are sufficiently distinctive to be of value for the purposes described herein in that they have a high level of permanency (they don't change much over time), and are readily collectable (as described herein).

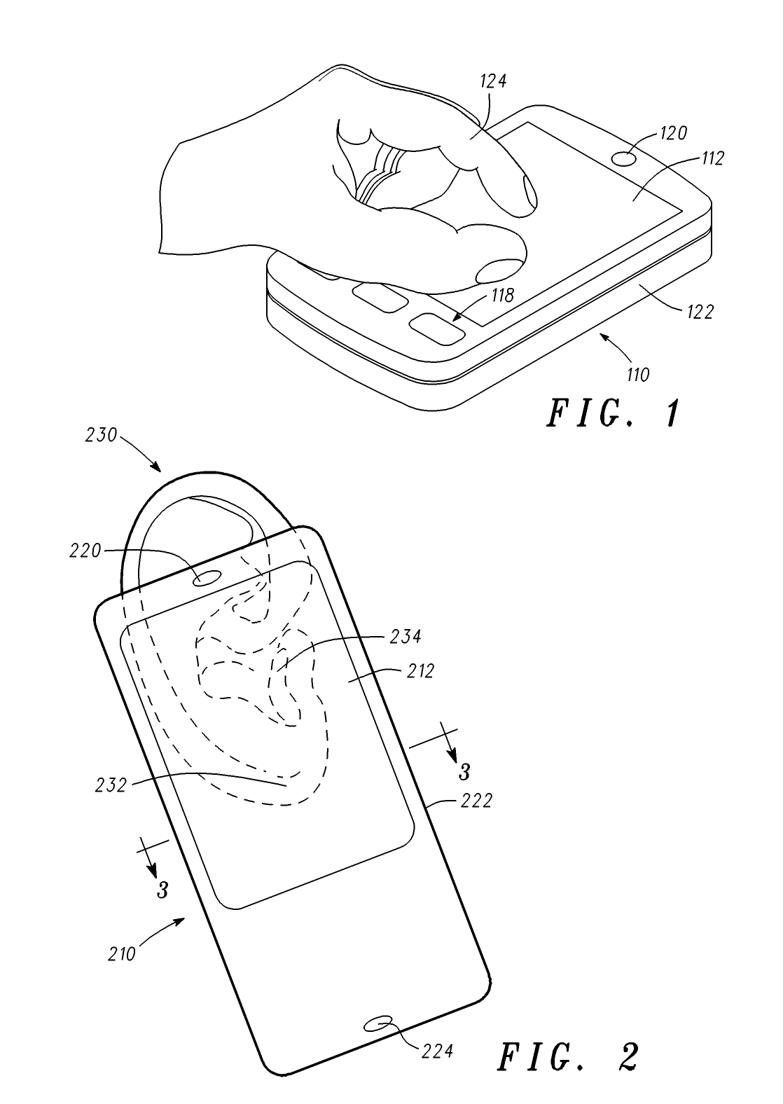

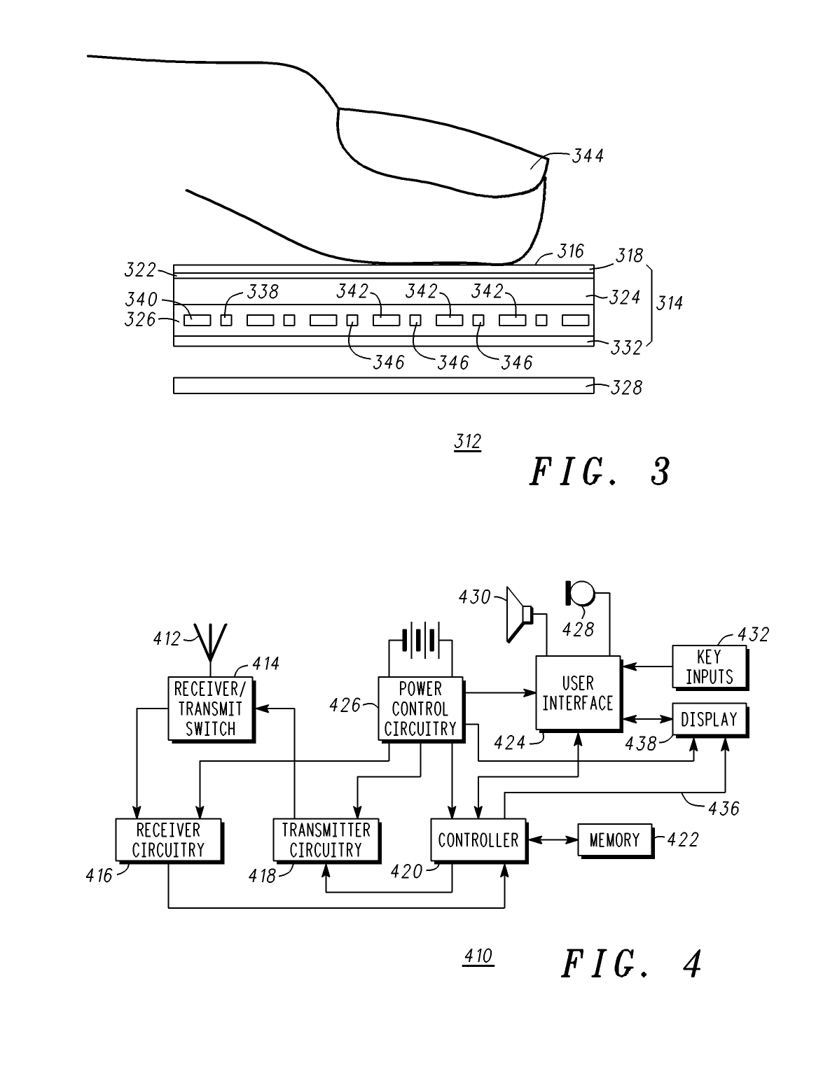

In another normal mode of phone use, e.g., executing a phone conversation, the device would be placed against the ear in such a manner that a significant portion of the ear, particularly the lower regions like the ear lobe and concha areas, would lie against the touch input display allowing for capture of the skin texture biometric from these areas. This mode may be beneficial if the user were wearing gloves, for example, preventing identification from finger touches. Referring to FIG. 2, an electronic device 210 (which may be any of the types of electronic devices mentioned above) is illustrated as a cell phone with a touch input display 212 (biometric device) positioned within a housing 222. The phone 210 will typically have a speaker 220 at one for delivering audio to the ear 230, a microphone 224 at the other to pick up voice input, and a large fraction of the phone's surface in between occupied by the touch input display 212. The touch input display 212 includes pixels and sensors (refer to discussion of FIG. 3 hereinafter) for providing a visual output and capturing light reflected from the skin of the ear 230, respectively. The phone 210 as illustrated is flipped 180 degrees, facing away from the ear 230 for ease of understanding. Normally the phone 210 will have the touch input display 212, speaker 220, and microphone 224 facing the ear 230 during use. During normal use, the phone 210 would be placed against the ear 230 in such a manner that a significant portion of the ear 230, particularly the lower regions like the distinctive lobe 232 and concha 234 areas, would lie against the touch input display 212 allowing for capture of the skin texture biometric. An optimal positioning of the speaker 220 with respect to the display area 212 could also generate a larger captured area.

In addition, it is very possible in this mode of operation, that the touch input display is also pressed against the flesh of the cheek (and possibly even the lips) where skin texture images could be captured as well, maybe even simultaneously.

Since phone conversations typically last an extended period of time, compared to the capture time, many inputs could be acquired for analysis to improve the accuracy of the biometric modality. And since most phone users position the phone underneath hair or caps covering the ear, and directly against the ear itself to achieve the best audio performance, this mode of acquisition is not hindered by such ear coverings.

Although the preferred exemplary embodiments of the phones 110 and 210 as shown illustrates a unitary body, any other configuration of wireless communication devices, e.g., flip phones, may utilize the invention described herein. The phones 110 and 210 typically includes an antenna (not shown) for transmitting and receiving radio frequency (RF) signals for communicating with a complementary communication device such as a cellular base station or directly with another user communication device. The phones 110 and 210 may also comprise more than one display and may comprise additional input devices such as an on/off button and a function button.

In yet another common mode of phone handling, the carrying of the phone in the palm or fingers of the hand, a skin texture image could be captured from the palm (or along the body of the fingers) surreptitiously. This mode of operation would be relevant during a call if the touch input display were on the opposite side of the phone from the speaker and microphone such that it would be against the palm of the hand instead of the ear and cheek during a call.

Other modes of flesh interaction with the touch display, either intentionally or unintentionally, can also be envisioned. Note that the phone may either be of the “bar” type, or the “flip” type in any of the embodiments.

There is a growing trend toward the use of touch input displays in high tier wireless communication devices, e.g., smart phones and PDAs. This is largely driven by the desire for efficient use of the limited surface area of the device. Typically, two user interface elements dominate the surface of the device: the keypad for input and the display for output. A touch input display input display (described in more detail hereinafter) combines the input and output user interface into a single element.

The touch input function can either be integrated into the display backplane or implemented in transparent layers applied over the surface of the display. There are at least three different touch input sensing technologies that have been demonstrated, including resistive, capacitive and optical, though an optical technology is envisioned for the embodiments described herein. With the proper array-based implementation, the optical mode is capable of generating characteristics of skin that is placed in contact with the surface. Because there are no lenses used to project and create an image, this approach is called a “near field” mode of capture. Only the portion of the skin that is in contact with the screen contributes to the characteristics.

The unobtrusive capture of this particular skin texture for biometric identification and verification provides several advantages over other biometric technologies, including: (1) skin texture biometrics are convenient and their acquisition tends to be perceived as less invasive, (2) skin texture geometry readers can work even under adverse conditions, e.g., dry, cracked, dirty skin, when fingerprint capture would fail, and (3) special sensors will not be required if the device employs an optical touchscreen.

Only the portion of skin in contact with an image detector is illuminated, with light scattered from the skin being received by the image detector. Characteristics are generated from the illuminated skin and analyzed. The image detector may be a monochromatic (black and white) imaging detector or a color imaging detector.

While varying from one person to the next, skin texture (composition and structure) is distinct and complex. A number of determinations may be made by conducting optical measurements of the spatiospectral properties of skin and its underlying tissue, including determining whether the skin is a living organism and performing identification or verification of the person's skin being sampled.

The epidermis, the outer most layer of the skin, overlies the dermis and hypodermis. The epidermis may include as many as five sublayers: stratum corneum, stratum ludidum, stratum granulosum, stratum spinosum, and stratum germinativum. Each layer, and their complex interfaces, will impart measurable characteristics within reflected light that is uniquely characteristic of an individual. Furthermore, protrusions from the dermis into the epidermis for the distribution of blood provides further unique and measurable characteristics.

Spectral and spatial characteristics received by the detector are identified and compared with spectral characteristics stored in a database. The spectral and spatial characteristics of a particular individual include unique spectral features and combinations of spectral features that may used to identify individuals. These spectral and spatial characteristics may be extracted by, e.g., discriminant analysis techniques.

Light reflected from the skin, and scattered thereby, may be subjected to various types of mathematical analyses for comparison with a specific reference. These analyses include moving-window analysis and block-by-block or tiled analysis, for example. Such analyses are described in detail in U.S. Patent Publication 2006/0274921 A1, incorporated herein by reference.

Regardless of which of these embodiments described herein, or other embodiments, is utilized, characteristics of the skin texture are made from the illuminated skin, and compared with stored characteristics of a person or persons skin. Values are assigned to the measurement comparisons. If the values are within a threshold, the identity of the person is verified.

Referring to FIG. 3, a cross section of the touch input display 312, comprising several pixels of a low-temperature polycrystalline silicon TFT-LCD display, is depicted with the cross-section, for example, being a portion of a view taken along line 3-3 of FIG. 2, and may comprise the display 112 or the touch input display 212, for example. This technology is described in a publication: “Value-Added Circuit and Function Integration for SOG (System-on Glass) Based on LTPS Technology” by Tohru Nishibe and Hiroki Nakamura, SID 06 Digest, hereby incorporated by reference. The display 312 includes a stack 314 with a user-viewable and user-accessible face 316 and multiple layers below the face 316, and typically includes a transparent cover 318, a thin transparent conductive coating 322, a substrate 324, an imaging device 326. The transparent cover 318 provides an upper layer viewable to and touchable by a user and may provide some glare reduction. The transparent cover 318 also provides scratch and abrasion protection to the layers 322, 324, 326 contained below.

The substrate 324 protects the integrated display 312 and imaging device 326 and typically comprises plastic, e.g., polycarbonate or polyethylene terephthalate, or glass, but may comprise any type of material generally used in the industry. The thin transparent conductive coating 322 is formed over the substrate 324 and typically comprises a metal or an alloy such as indium tin oxide or a conductive polymer.

Though the exemplary embodiment described herein is an LCD, other types of light modulating devices, for example, an electrowetting device, may be used.

An electroluminescent (EL) layer 328 is disposed contiguous to the ITO ground layer and includes a backplane and electrodes (not shown) as known to those skilled in the art and which provides backlight for operation of the display 312 in both ambient light and low light conditions by alternately applying a high voltage level, such as one hundred volts, to the backplane and electrodes. The ITO ground layer 332 is coupled to ground and provides an ITO ground plane for reducing the effect on the imaging device 326 of any electrical noise generated by the operation of the EL stack layer 328 or other lower layers within the display 312. The various layers 318, 322, 324, 326, 332, are adhered together by adhesive layers (not shown) applied therebetween. Although the EL layer 328 is preferred, other light sources, such as a light emitting diode, may alternatively provide radiant energy to the layers 332, 326, 324, 322, and 318. Alternatively, the EL layer 328 may be other types of light sources, for example, an LED or a field emission device. This radiant energy may span the visible range of wavelengths to accommodate the display requirements, but may also include near infrared to accentuate skin texture image capture and analysis.

The imaging device 326 comprises a plurality of pixels 338 for producing displayed images (black and white, black and white including shades of gray, or color) and illumination of skin texture (a single wavelength, a spectral band, or a plurality of spectral bands), and a plurality of photosensors 340 for sensing touchscreen inputs on the transparent cover 318 of the display 312 and for capturing reflected images of the skin texture. Each pixel 338 has a photosensor 340 associated therewith. When three pixels are grouped to form a triad of pixels to represent a color image, one photosensor 340 may be positioned with each triad, or with each pixel in the triad, or may be more sparsely populated within the imaging device 326.

In order to prevent the entire display from lighting when the finger touches a small portion, those photosensors 342 detecting the touch of the finger 344 (FIG. 3) will cause only those pixels 346 associated therewith to emit light for skin illumination. Though three photosensors 342 and three pixels 346 are affected by the touch of the finger 344 as illustrated, it should be understood that a plurality of photosensors and pixels could be so affected. This illumination of only some of the pixels avoids a distraction to the user (if the entire display were illuminated), would compromise the unobtrusiveness of the biometric capture, and provides efficient use of limited battery energy of the electronic device. Regions not underlying the skin touch would function as conventional display pixels, producing the image viewed on the display which may include “target” portions for the skin touches.

In one exemplary embodiment and as known in the art, the touch input display 312 includes a layer of liquid crystal molecules formed between two electrodes. Horizontal and vertical filter films are formed on opposed sides of the imaging device 326 for blocking or allowing the light to pass.

The electrodes in contact with the layer of liquid crystal material are treated to align the liquid crystal molecules in a particular direction. In a twisted nematic device, the most common LCD, the surface alignment directions at the two electrodes are perpendicular and the molecules arrange themselves in a helical structure, or twist. Light passing through one polarizing filter is rotated by the liquid crystal material, allowing it to pass through the second polarized filter. When a voltage is applied across the electrodes, a torque acts to align the liquid crystal molecules parallel to the electric field. The magnitude of the voltage determines the degree of alignment and the amount of light passing therethrough. A voltage of sufficient magnitude will completely untwist the liquid crystal molecules, thereby blocking the light.

Referring to FIG. 4, a block diagram of a wireless communication device 410 such as a cellular phone, in accordance with the exemplary embodiment is depicted. The wireless electronic device 410 includes an antenna 412 for receiving and transmitting radio frequency (RF) signals. A receive/transmit switch 414 selectively couples the antenna 412 to receiver circuitry 416 and transmitter circuitry 418 in a manner familiar to those skilled in the art. The receiver circuitry 416 demodulates and decodes the RF signals to derive information therefrom and is coupled to a controller 420 for providing the decoded information thereto for utilization thereby in accordance with the function(s) of the wireless communication device 410. The controller 420 also provides information to the transmitter circuitry 418 for encoding and modulating information into RF signals for transmission from the antenna 412. As is well-known in the art, the controller 420 is typically coupled to a memory device 422 and a user interface 424 to perform the functions of the wireless electronic device 410. Power control circuitry 426 is coupled to the components of the wireless communication device 410, such as the controller 420, the receiver circuitry 416, the transmitter circuitry 418 and/or the user interface 424, to provide appropriate operational voltage and current to those components. The user interface 424 includes a microphone 428, a speaker 430 and one or more key inputs 432, including a keypad. The user interface 424 would also include the display 438 which includes touch screen inputs. The display 438 is coupled to the controller 420 by the conductor 436 for selective application of voltages.

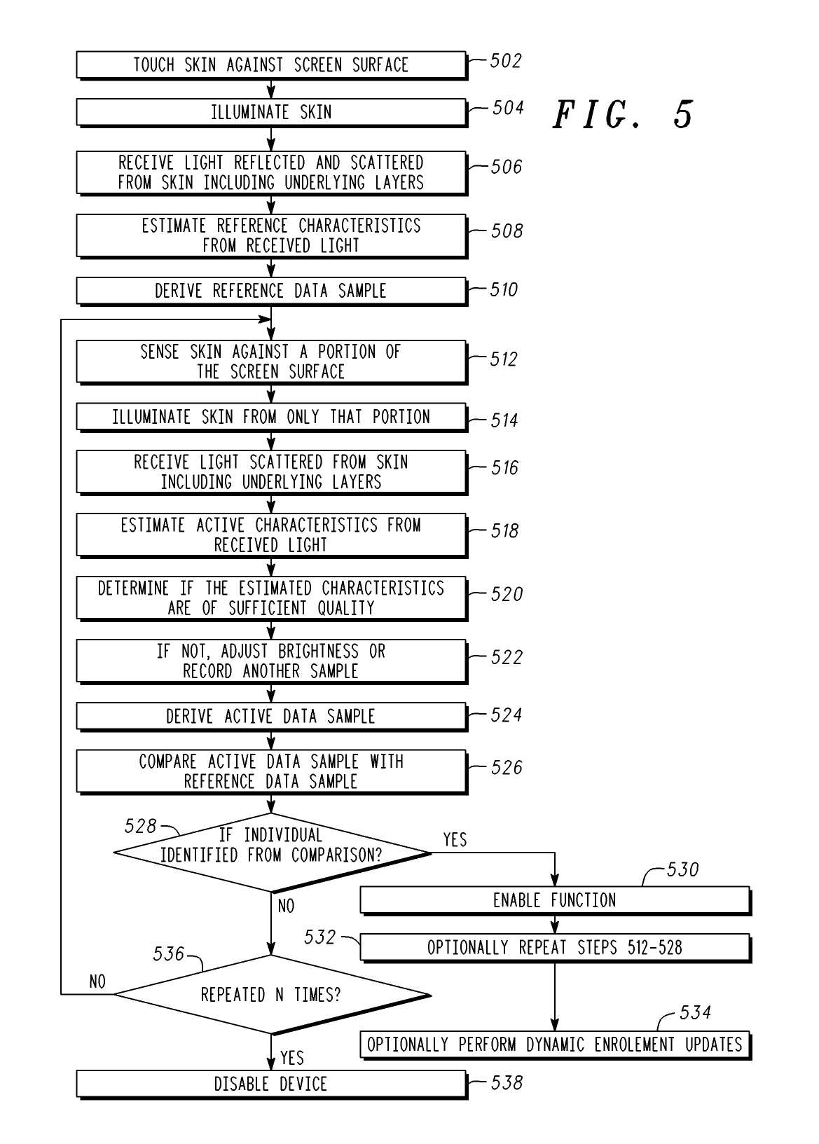

Referring to FIG. 5, a method will be described for identifying and verifying a person in accordance with exemplary embodiments, in which data is taken (stored) of skin texture. As used herein, the words “capture”, “record”, “store” are meant to be used generically and interchangeably and mean that data is electronically captured.

In accordance with the exemplary embodiment and illustrated in FIG. 5, as skin is touched 502 against the display surface, the display provides 504 radiant energy (illumination) to the skin. Reflected and scattered radiant energy is received 506 from the skin including its underlying layers and reference characteristics are estimated 508 from the received light. A reference data sample of the skin texture is derived 510 and stored for later verification during normal use. The reference data sample may be taken, for example, when the wireless communication device is first purchased or when loaned to a friend. The recording of reference data samples is enabled by software and may be password protected. Corrections made to the data sample may include, for example, filtering out noise. A statistical model of the data sample may be formed. Combinations of data within the data sample, such as ratios or logical comparisons, may also be determined. These values are stored for later comparison with data samples taken during use of the wireless communication device.

During normal use, when a user touches the display and the skin is sensed 512, the display provides 514 radiant energy (illumination) to that portion touched by the skin. The radiant energy may be a single wavelength, a spectral band, or a plurality of spectral bands. Reflected and scattered radiant energy is received 516 from the skin including its underlying layers and active characteristics are estimated 518 from the received radiant energy. A determination 520 is made if the estimated characteristics are of sufficient quality. If not, the skin texture image quality may be improved by adjusting 522 the brightness of the illumination, the spectral balance of the illumination, or recording another sample.

An active data sample of the skin texture is derived 524. This second data sample is passively captured without any specific, intentional action taken by the user. The above steps are repeated wherein corrections are made to the data sample including, for example, filtering out noise. A statistical model of the active data sample may be formed. Combinations of data within the active data sample, such as ratios or logical comparisons, may also be determined. These values are then compared 526 with stored values from the reference data sample(s). The comparison may be carried out using any method of comparing quantities or sets of quantities, e.g., by summing squared differences. Values are assigned based on the comparison, and a determination is made whether the values are within a threshold. If the values are within a threshold, the identity of the person whose skin is being scanned is verified 528 and one or more specific functions of the wireless communication device is enabled 530. The functions may include, for example, allowing use in the most basic sense and configuring, or tailoring (personalizing), the wireless communication device to a particular user. If the values are not within a threshold, the identity of the person whose skin is being scanned is not verified 528, the steps 512-528 may be repeated 536 a number N times. If not verified within N times, the device would be disabled 538. The number N is some integer, such as 3, determined to provide a reasonable opportunity to obtain an accurate image of the finger.

Each of the steps 512 through 528 may be repeated 532 for a continuing verification that the user is an authorized user. This repeating of steps 512 through 528 would prevent, for example, an unauthorized user from using the device after the user has been authenticated. These steps 512-528 are performed with no intentional action by the user of the electronic device. Additionally, an optional dynamic enrollment update 534 may be performed by comparing each of the active data samples with the original data sample and adjusting an acceptable range of to be received active data samples based on the original data sample and additional active data samples.

In another exemplary embodiment, the above described method of verifying the user based on a data sample taken may be only one of several biometric measurements taken for verification. An attempt to take two or more biometric samples, such as a voiceprint, a picture of the user's face, a fingerprint, as well as a skin texture data sample may be made. Since one particular biometric sample may not be obtainable, a successful capture of another biometric sample may enable a function on the wireless communication device.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method for enabling a function on an electronic device comprising a touch input device including a plurality of pixels having a surface for providing radiated energy, and a plurality of photosensors, each of the pixels being associated with a sensor, the method comprising:
during functional use of the electronic device by a user:
touching skin of the user against a portion of the surface of the touch input device;
sensing that portion of the touch input device that is touched by the user's skin;
applying radiant energy toward the skin from only that portion of the touch input device touched by the skin;
collecting radiant energy reflected from the skin by at least a portion of the plurality of photosensors;
converting the collected radiant energy into data; and
enabling the function when the data corresponds to a reference sample.

2. The method of claim 1 further comprising displaying an image by the touch input device not touched by the skin.

3. The method of claim 1 wherein the touch input device comprises one of a push button or a touch screen.

4. The method of claim 1 wherein the user's skin comprises a portion of one of a finger, an ear, a face, and a lip.

5. The method of claim 1 wherein the applying step comprises applying radiant energy including a plurality of spectral bands.

6. The method of claim 1 further comprising:
prior to functional use of the electronic device:
touching skin of the user against the surface of the touch input device;
applying radiant energy generated by the touch input device to the user's skin;
collecting, by the plurality of photosensors, radiant energy reflected from the skin;
converting the collected radiant energy into data; and
storing the data as the reference sample.

7. The method of claim 6 wherein the applying radiant energy generated by the touch input device to the user's skin step comprises applying radiant energy to the user's skin to first and second locations on the user's body to provide a first reference sample and a second reference sample, respectively.

8. The method of claim 6 wherein the applying radiant energy steps comprises optimizing at least one of the spatial, spectral, and brightness of the radiant energy.

9. The method of claim 6 wherein the steps prior to functional use are repeated during functional use to provide an updated known sample, and wherein the enabling step comprises enabling the feature when the reflected radiant energy corresponds to one of the first or second reference sample.

10. The method of claim 6 wherein the applying radiant energy steps comprises applying radiant energy having a plurality of multiple spectral bands, and the collecting steps comprise collecting reflected multiple spectral bands for determining the skin texture.

11. The method of claim 6 wherein the applying and collecting steps comprise applying and collecting a broadband spectral range.

12. A method for enabling a feature on an electronic device, comprising:
sensing skin by a portion of a touch input screen;
illuminating the skin with radiated energy emitted from only the portion of the touch input screen;
receiving scattered radiation back from the skin;
estimating active characteristics from the received scattered radiation;
comparing the active characteristics with reference characteristics; and
enabling a function of the electronic device if the comparison of the active characteristics and the reference characteristics are within a defined range of values.

13. The method of claim 12 wherein the illuminating step comprises illuminating with a plurality of spectral bands.

14. The method of claim 12 wherein the illuminating step comprises illuminating with a plurality of spectral bands.

15. The method of claim 12 further comprising:
performing initializing steps to determine the defined range of values, comprising:
touching skin against the touch input device;
illuminating the skin with radiated energy emitted from the touch input screen;
receiving scattered radiation back from the skin;
estimating reference characteristics from the received scattered radiation; and
storing the reference characteristics.

16. The method of claim 15 wherein the illuminating steps comprise illuminating with a plurality of spectral bands, and the receiving steps comprise receiving scattered multiple spectral bands for determining the skin texture.

17. A method for capturing skin texture characteristics to enable an electronic device, comprising:
touching skin of a user of the electronic device against a portion of a touch input display screen, the touch input display screen capable of being illuminated;
surreptitiously performing the steps comprising:
illuminating the skin from only that portion touched;
receiving reflected illumination from the skin by the touch input display; and
enabling a function of the electronic device if characteristics of the reflected illumination match stored reference characteristics.

18. The method of claim 17 wherein the illuminating step comprises illuminating with a plurality of spectral bands.

19. The method of claim 17 further comprising:
prior to touching skin against a portion of the touch input display screen:
touching skin of the user against the surface of the touch input device;
illuminating the skin;
receiving reflected illumination from the skin by the touch input display; and
converting the collected radiant energy into reference characteristics; and
storing the reference characteristics.

20. The method of claim 19 wherein the illuminating steps comprises illuminating with a plurality of spectral bands, and the receiving steps comprise receiving reflected multiple spectral bands for determining the skin texture.
